(19) United States
(12) Patent Application Publication
(10) Pub. No.: US 2018/0171870 A1
(43) Pub. Date: Jun. 21, 2018

(54) ELECTROCATALYTIC SYSTEM FOR REDUCING PULLUTION AND FUEL CONSUMPTION

(71) Applicants: Farhad Salek, Mashhad (IR); Mohammad Reza Safari, Mashhad (IR); Mohammad Mahdi Naserian, Mashhad (IR); Alireza Naghavi Moghaddam, Mashhad (IR); Alireza Jahantigh, Mashhad (IR)

(72) Inventors: Farhad Salek, Mashhad (IR); Mohammad Reza Safari, Mashhad (IR); Mohammad Mahdi Naserian, Mashhad (IR); Alireza Naghavi Moghaddam, Mashhad (IR); Alireza Jahantigh, Mashhad (IR)

(21) Appl. No.: 15/899,341

(22) Filed: Feb. 19, 2018

(30) Foreign Application Priority Data
Feb. 17, 2017 (IR) 13955014000301463

(51) Int. Cl. F02C 6/18; F02D 41/00; F02D 19/06; F02B 47/02

(52) U.S. Cl. CPC F02C 6/18; F02D 41/0027; F02D 19/0671; F22B 1/1815; F02D 19/0644; F02B 47/02; F02D 19/066

(57) ABSTRACT

An improved electrocatalytic system utilizes an Organic Rankine cycle system to take advantage of exhaust fume heat to convert a working fluid to steam used in a steam expander to generate electricity. The generated electricity is then used in electrolyzing water to produce hydrogen gases used as a supplemental fuel in an internal combustion (IC) engine. Thereby, the improved electrocatalytic system provides an efficient, less costly and retrofittable system for reducing harmful emissions and fossil fuel consumption in vehicles.

### CROSS REFERENCE TO RELATED APPLICATION

This application claims the benefit of priority to Iran Application Serial Number 139550140003014638, filed on Feb. 17, 2017, the entire content of which is incorporated herein by reference.

### TECHNICAL FIELD

This subject matter relates generally to converting exhaust fume heat to electricity in an internal combustion engine, and more particularly to generating hydrogen from the energy of engine emissions in existing internal combustion engines while minimizing engine retrofitting and reducing engine emissions.

### BACKGROUND

Great efforts have been spent in recent years in developing system that reduce the amount of fossil fuel consumption and harmful emission of internal combustion (IC) engines. Hybrid vehicles are one of such systems. In hybrid vehicles, a high-power electric motor is used along with an IC engine for power. The IC engine helps charge the electric motor which is in turn used to drive the vehicle for some distance before the electric motor loses its charge. Although, this mechanism reduces emission and fossil fuel consumption, due to the complexity of the transmission lines in these vehicles, which are linked to two sources of power, it is very difficult to retrofit a regular fossil fuel vehicle with a hybrid system. Additionally, hybrid vehicles are sometimes difficult to charge, particularly in public places, because charging stations for these vehicles are not yet commonly established. Another disadvantage of hybrid vehicles is the rapid discharge of the systems' batteries.

Another type of system used to reduce harmful emissions in IC engines utilizes a electrocatalytic converter. In a typical gasoline-run vehicle, the use of an electrocatalytic converter helps reduce emissions and fuel consumption and avoids some of the disadvantages of hybrid systems. Although such electrocatalytic converter systems have many advantages, their operations can be substantially improved.

Therefore, a need exists for providing an improved electrocatalytic converter system for use with IC engines that efficiently reduces harmful emissions and reduces fuel consumption.

### SUMMARY

A system for reducing fossil fuel consumption and emissions in an engine is provided. In one implementation, the system includes a waste heat recovery unit including a condenser connected to a first pump for injecting a working fluid into a heat exchanger configured to convert the working fluid into steam injected into an expander; a generator connected to the expander for generating electricity; a battery for storing the generated electricity; and a water electrolysis unit including a water container for storing water, and a second pump for pumping the water into an electrocatalytic converter. The electrocatalytic converter includes a plurality of electrode plates for conducting the generated electricity through the water to electrolyze the water and generate a hydrogen gas for injection into the engine. The hydrogen gas reduces an amount of fossil fuel needed for running the engine and reduce engine emissions, and the heat exchanger uses heat from exhaust fumes emitted from the engine to convert the working fluid to steam.

### BRIEF DESCRIPTION OF THE DRAWINGS

Features of the subject technology are set forth in the appended claims. However, for purpose of explanation, several implementations of the subject technology are set forth in the following figures.

FIG. 1 is a schematic drawing of an improved electrocatalytic system for use in a motor vehicle.

FIGS. 2A-2B are schematic drawings of heat exchange tubes for use in the improved electrocatalytic system.

FIG. 3 is a schematic drawing of an electrocatalytic converter for use in the improved electrocatalytic system.

FIG. 4 is a schematic drawing of a portion of the electrocatalytic converter of FIG. 3.

FIG. 5 is a schematic drawing of input and output gases into and out of an IC engine of the improved electrocatalytic system.

FIGS. 6A-6B are a block diagrams of energy transfer in conventional hydrogen production and injecting systems and the improved electrocatalytic system, respectively.

FIGS. 7A-7B are schematic drawings of electrode plates used in an improved electrocatalytic system for use in a motor vehicle.

FIG. 8 is a schematic drawing of an improved electrocatalytic system for use in a motor vehicle.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. As part of the description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

Recent demands for reduction in fuel consumption and harmful emissions of IC engines have led to the use of electrocatalytic systems in vehicles. An electrocatalytic converter may be installed in gasoline-run vehicles to convert water to hydrogen and oxygen which is then injected into the intake air of the IC to reduce fuel consumption and emissions. However, such systems generally require electrical energy to be supplied to the electrode plates of the electrocatalytic systems. This electric energy is often supplied by the vehicle's main battery which results in rapid discharge of the battery. Furthermore, the battery is generally charged by the alternator which is connected to the motor (engine crank shaft). This means that the energy of the electrode plates of the electrocatalytic converter is supplied from the energy (mechanical power) of the vehicle engine. This in itself creates a source of energy inefficiency.

A solution is proposed here to solve these issues and more by providing an improved electrocatalytic system for use in motor vehicles. In one embodiment, the improved electrocatalytic system involves converting the heat generated by exhaust fumes to electrical energy which then powers an electrocatalytic converter. By reusing the engine's energy loss through the exhaust system, the improved system reduces fuel consumption, increases engine efficiency and reduces engine emissions.

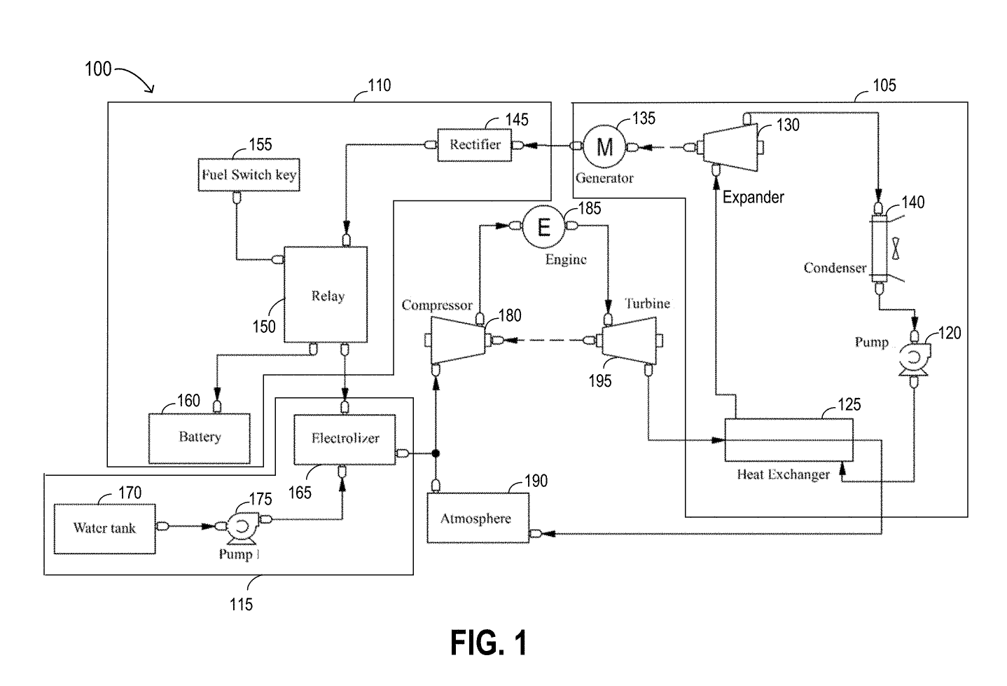

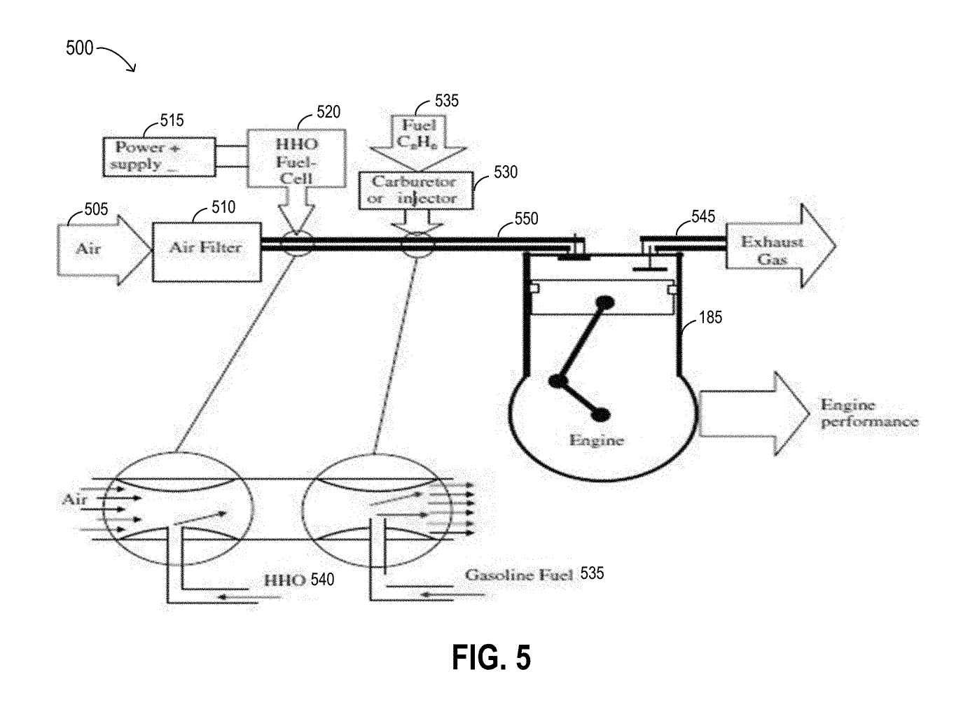

FIG. 1 illustrates one implementation of an improved electrocatalytic system 100 for use in motor vehicles. System 100 includes three main sections, an energy generating section 105, an electric transmission and control section 110, and a water electrolysis section 115. The energy generating section 105 includes a pump 120 for pumping a fluid into a heat exchanger 120. The pump 120 increases the flow pressure of the fluid entering the pump with an internal mechanism such as an impeller (not shown) to push the fluid into the heat exchanger 125. The heat exchanger 125 may be a tube that is installed inside the exhaust pipe (see FIG. 5) of the vehicle for transferring the heat of the exhaust fumes to the fluid passing through an inner shell of the heat exchanger 125. As a result of the heat applied by the exhaust fumes, the fluid is vaporized to turn into steam which is then fed to the first expander 130. In one implementation, the working fluid used in system 100 is one that has a low boiling temperature and low heat of vaporization, such as 1,1,1,3,3-Pentafluoropropane (also known as “R245fa”). R245fa is a chemical with low saturation pressure and other thermo physical properties that make its use in a heat recovery system such as the system 100 highly desirable. As a result, by using a fluid such as R245fa as the working fluid, system 100 can generate electricity and provide the energy needed for the electrolysis system even when the exhaust gas temperature is minimal (e.g. when the vehicle is running at low speeds). This is highly advantageous as when a vehicle is running at low speeds, the engine often has the most pollutant emissions. Moreover, use of R245fa does not negatively impact the environment.

Once the working fluid is vaporized, it enters the expander 130 where the pressure created by the steam moves the expander blades (not shown) thus causing the expander to start rotating. The rotation causes an output shaft (not shown) of the expander 130 to turn. The output shaft of the expander 130 is connected to an electric generator 135. The rotation of the expander shaft causes the electric power generator 135 to produce electricity with a voltage range and alternating current.

After moving through the expander 130, the steam is routed to a condenser 140 for converting the steam back to liquid. In one implementation, the condenser 140 includes a fan (not shown) for cooling. Using the fan, the steam is converted from vapor to liquid form before moving back into the pump 120 to be pumped into the heat exchanger 125 for another cycle. This cycle may be referred to as an Organic Rankine cycle, which is known in the art as a cycle where an operating organic fluid is continuously evaporated and condensed.

In addition to the energy generating section 105 for producing electric energy, the system 100 includes an electric transmission and control section 110. The electric transmission and control section 110 includes, in one implementation, a rectifier 145 which may be a diode bridge rectifier used for converting alternating-current (AC) to direct-current (DC). Once converted, the DC current enters a relay switch 150 which is connected to a fuel switch key 155. The fuel switch key 55 may be located inside the vehicle for easy accessibility for a user of the vehicle. For example, the fuel switch key 155 may be placed around the steering vehicle for enabling the driver to select the type of fuel they desire to use for the vehicle at a given time. The switch may present two options to the driver for selecting either a single only fuel mode or a hybrid fuel mode. When the gasoline only fuel option is selected, power is not sent from the fuel switch key 155 to the relay 150. As a result, the relay contact does not change, which causes the electrical energy generated by the energy generating section 105 to flow into the battery 160. In this manner, the electric energy is stored in the battery 160 for future use. When the fuel switch key 155 is on the hybrid fuel mode, electric energy is sent to the relay 150, thereby changing the contact of the relay such that the energy produced by the energy generating section 105 is transferred to the electrocatalytic converter plates 165.

The battery 160 is, in one implementation, a hybrid battery system having 12 or 24 volts, or a different voltage. The battery 160 is charged when the vehicle is in single-fuel mode. The energy stored on the battery 160 can be used to supply energy to the first pump 120 of the energy generating section 105, the water transfer pump 175 of the water electrolysis section 115 and/or the cooling fan of the condenser 140. The battery 160 can also be used when there is a problem with the main battery of the vehicle. In this manner, the system 100 not only does not require additional energy for operation, but also can be used to supplement the vehicle's battery, when needed.

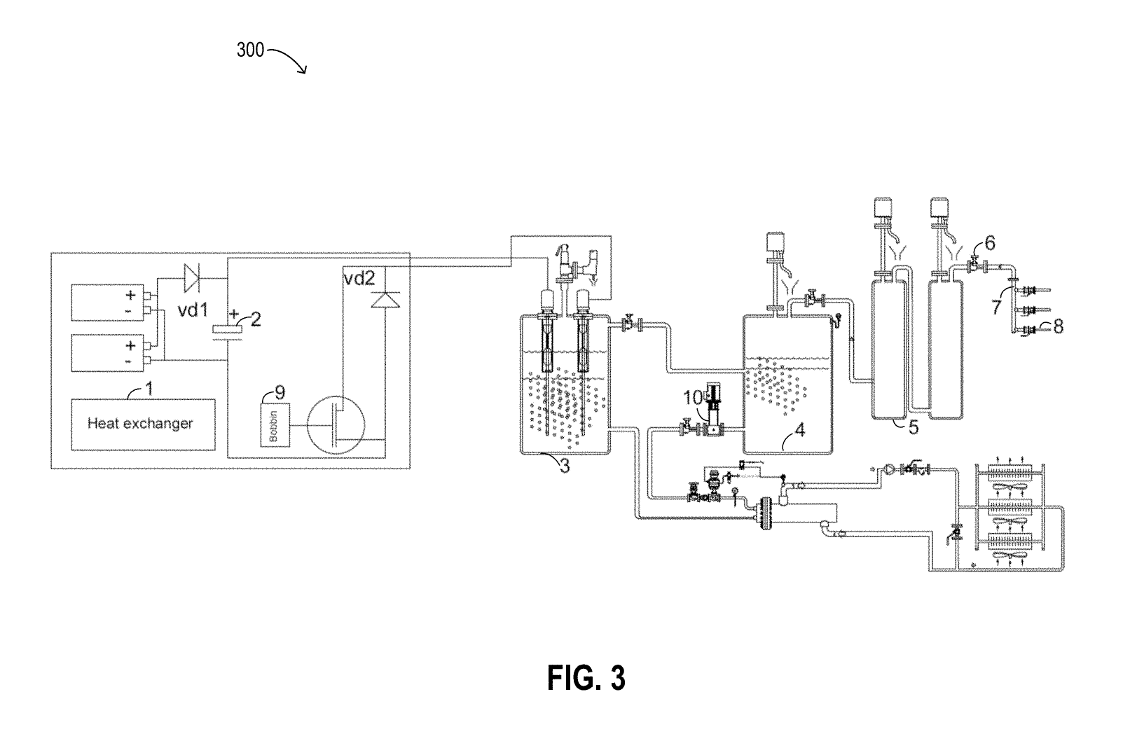

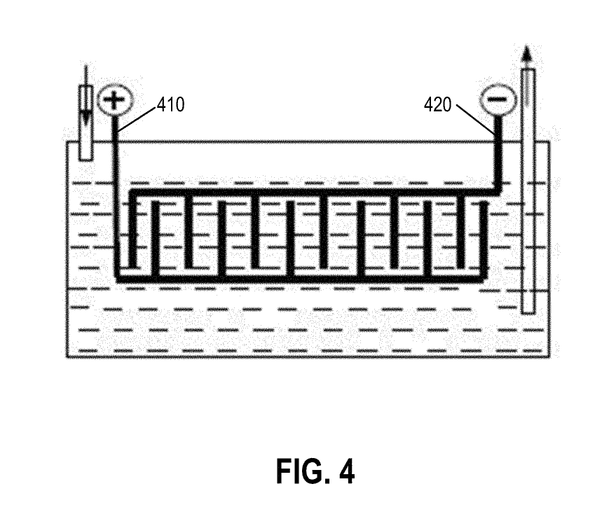

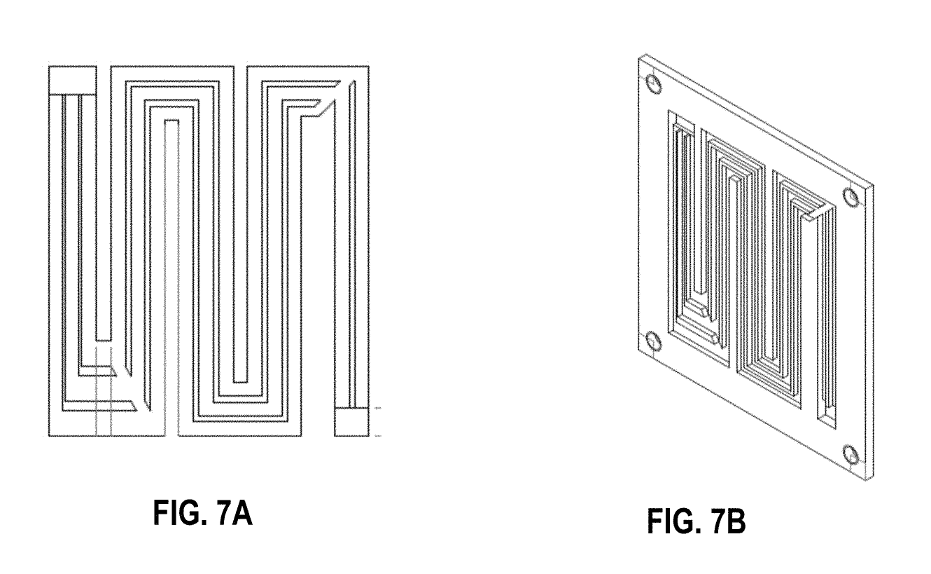

The water electrolysis section 115 of system 100 includes a water tank 170, a water transfer pump 175 and the electrocatalytic converter 165. The water tank 170 contains water used in the electrolysis mechanism. The water transfer pump 175 is connected to and transfers water from the water tank 170 to the electrocatalytic converter 165. The electrocatalytic converter 165 contains electrode plates (see FIG. 4) that are placed inside a container (see FIG. 3) filled with water. In one implementation, the electrocatalytic converter 165 includes electrode plates having increased contact surfaces. To achieve this, in one implementation, the surface of the electrode plates facing each other may be indented to form vertical and/and horizontal grooves, which cause more contact between the surface areas of the two electrodes. This is illustrated in FIGS. 7A-7B. As a result of the grooves, the surface of the two electrodes almost act as gears that fit into each other. The opposite surface of each electrode plate is in contrast flat and without any indentations. The increased contact between surface areas of the two electrodes increase electrode surface contact with the electrolyte fluid which results in generating in the electrolysis process and increase current density in the contact regions.

By supplying electrical current to the electrode plates, the water inside the electrocatalytic converter 165 is electrolyzed to produce oxygen and hydrogen gases. The produced oxygen and hydrogen gases are then transported to the combustion chamber (not shown) of the IC engine 185. Thus, the engine is fed with oxygen and hydrogen gases in addition to the traditional source of fuel it uses for operation. These oxygen and hydrogen gases increase the thermal value of the traditional fuel and as a result increase its combustion, thereby decreasing the amount of fossil fuel needed for the engine's operation. To reduce the amount of fossil fuels used by the system 100, when the electrocatalytic converter 165 begins injecting oxygen and hydrogen into the combustion chamber of the IC engine 185, an oxygen sensor (not shown) sends an enriched-fuel message to an engine control unit (ECU) (not shown) to inform the ECU of the existence of oxygen and hydrogen fuel. As a result, the ECU reduces the fuel injection rate of the injectors that provide the fossil fuel to the engine 185. ECUs are well known in the art and as such their structure and function is not described in detail here. However, even though, the amount of traditional fuel used by the engine is reduced, the mechanical energy of the engine will remain the same as before, as hydrogen is substituting some of the required fossil fuel.

After burning the fuel, emitted gases from the engine 185 are routed to the turbine 195 to be transferred to the heat exchanger 125, where their heat is utilized for vaporizing the working fluid, before they are routed through the exhaust pipe outlet (see FIG. 5) to the atmosphere 190. In this manner, the energy of the emitted gases is used efficiently to contribute to the operation of the IC engine 185.

It has been established that vehicles often produce the most amount of pollutants when they are running on low speeds. For example, when a bus stops at the bus station or vehicles are stuck in traffic or waiting behind a red light, they generate the most of amount of pollutants. The inventors have determined that if system 100 is activated when the vehicle is running at a slow speed, in one implementation, the organic Rankine cycle can supply the electrocatalytic convertor power requirement completely because the low boiling temperature of the organic working fluid. This means that, in one implementation, the system 100 achieves its best results when the system is activated while the vehicle is running at a slow speed (and low exhaust gas temperature) and producing increased pollutant emissions. The performance of this system 100 is almost the same as hybrid vehicles.

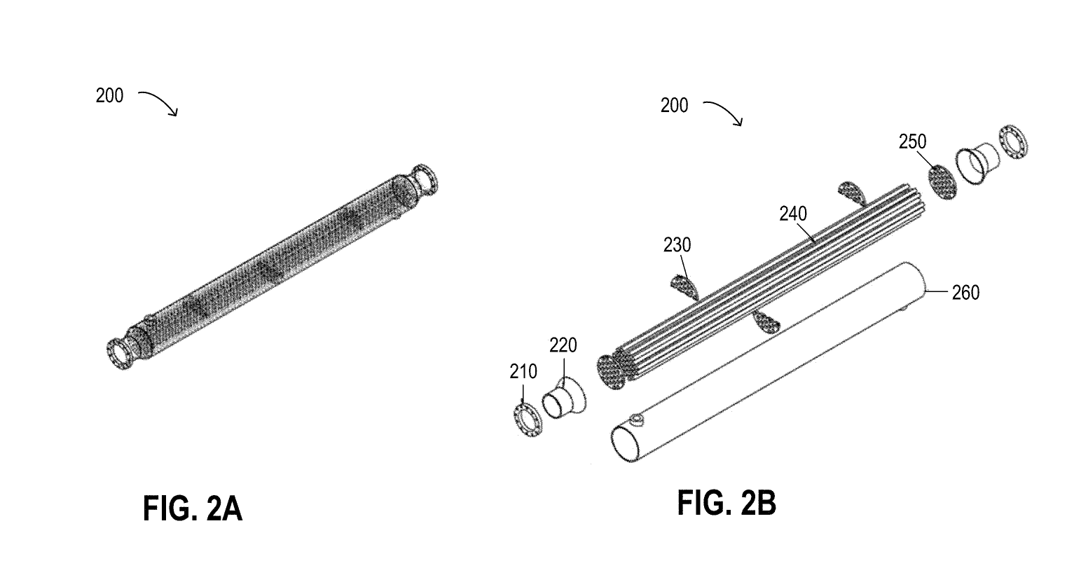

FIG. 2A depicts a heat exchange tube 200 that forms part of the heat exchanger 125 of FIG. 1. FIG. 2B depicts the various internal and external parts of the heat exchange tube 200. As shown, the heat exchange tube 200 includes an outer shell 260 that covers an internal grooved tube 240. The grooves in the grooved tube 240 allow the working fluid to pass through the inside layer of the heat exchange tube 200 (the skin area between the tube 240 and the inside of the outer shell 260, while exhaust fumes travel through the inner housing of the tube 240. The heat exchange tube 200 also includes, on each end, a flange 210 for fitting over a duct 220 which attaches to a cap 250. Additionally, the heat exchange tube 200 includes a plurality of baffles 230 in the shell 260 for restricting the flow of the working fluid inside the heat exchange tube 200. In one implementation, a shell and tube type heat exchanger are chosen because they exhibit has lower backpressure than other types heat exchangers.

The length of the heat exchange tube 200 can vary depending on the size and dimensions of the vehicle and/or other variables. For example, the length of the heat exchange tube 200 could extend up to 2 meters. In one implementation, multiple heat exchange tubes 200 are used to form a triangular arrangement with a 30 degrees angle between each two heat exchanger tubes, for maximum efficiency. According to some analyses conducted by the inventors, the heat exchanger 125 is capable of transferring about 70% of the exhaust gas heat to the working fluid with a back pressure of less than 30 kPa. Thus, the working fluid enters the skin of the heat exchange tube 200 in a liquid state and exits a superheated steam state.

FIG. 3 depicts the internal elements of the electrocatalytic converter 165, in one implementation. The electrocatalytic converter 165 includes a heat exchanger 1 connected to a capacitor 2 that functions as a wave filter and a first flow control circuit 9. The capacitor 2 is also connected to a second flow Control circuit 3, which is in turn connected to an electrolyte tank 4 for holding the water. The electrolyte tank 4 is connected to an input path 10 for routing the electrolyte to the electrolyte tank 4. The electrocatalytic converter 165 also includes a double-headed valve 5 which is connected to a one-way outlet 6 attached to a header 7. The header 7 connects to an outlet 8 which is routed to the engine manifold. The double headed valve 5 is used to dehydrate the generated hydrogen and oxygen gases.

In one implementation, the electrocatalytic converter 165 is different from currently used electrocatalytic converters in at least a few ways. For example, as discussed above, the electrode plates used in the electrocatalytic converter 165 have increased contact areas. Furthermore, to increase the conductivity of the electrocatalytic converter 165, two types of steel may be used for the cathode and anode plates. For example, stainless steel 302 and 304 may be used for the cathode plate and steel 316L may be used for the anode plates. Moreover, in one implementation, an inverse electron pump is created by placing two absorbing poles in the outlet path. The absorbing poles introduce a stimulating force to the ion gases produced by the electrocatalytic converter, which generally increases the engine's volumetric efficiency. In another implementation, an active carbon filter fuel dryer is also utilized in the electrocatalytic converter for dehydrating the generated hydrogen and oxygen gases.

FIG. 4 depicts the layout of the electrode plates in the electrocatalytic converter 165. As shown, each of the cathode 410 and anode 420 include a plurality of plates that are positioned inside an electrolyte tank such that each cathode plate is adjacent to an anode plate.

FIG. 5 depicts a block diagram 500 of input and output gases into and out of an IC engine of the improved electrocatalytic system. As shown, air 505 passes through an air filter 510 to enter into an inlet manifold 550 of the engine 185. The inlet manifold 550 also receives hydrogen gases generated inside the HHO fuel cell 520 which is powered by the power supply 515. As discussed above, the hydrogen gas is generated inside the HHO fuel cell 520 from HHO 540 (water). The inlet manifold 550 also receives gasoline fuel 535 from a carburetor or injector 530. Thus, the hydrogen gas is mixed with the fossil fuel to increase its combustibility and thus the efficiency of the engine 185. After the fuels are used in the engine 185, exhaust gas is produced as a byproduct which is routed to the exhaust manifold 545.

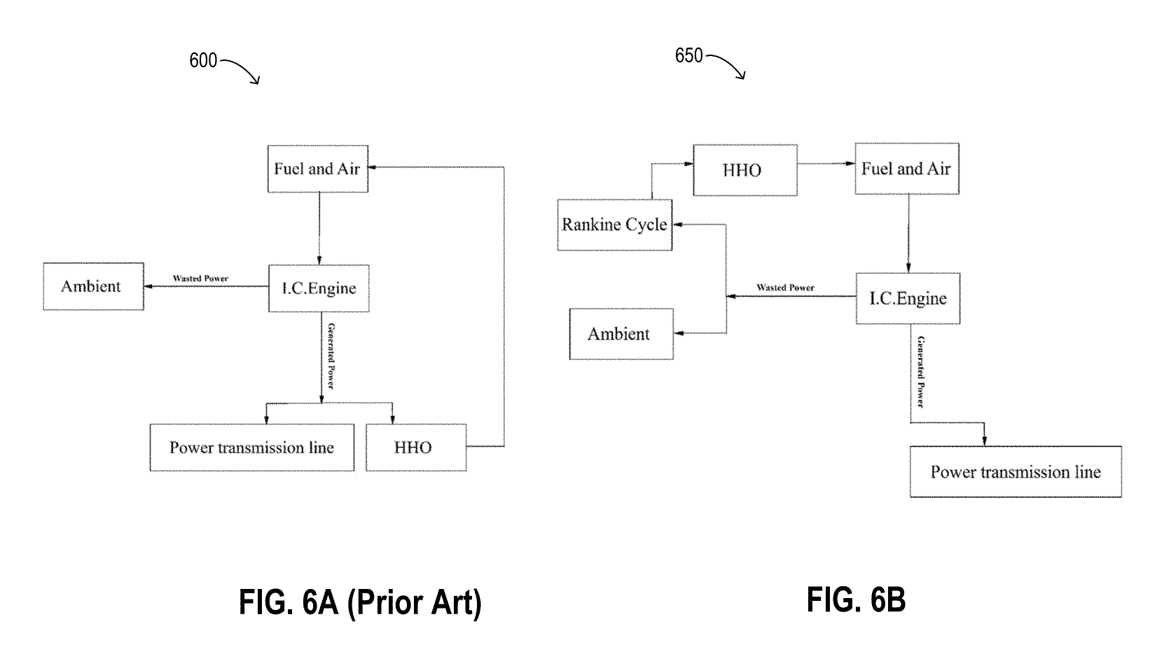

FIG. 6A depict a block diagram of energy transfer in conventional hydrogen production and injecting systems, and FIG. 6B depict a block diagram of energy transfer in the improved electrocatalytic system disclosed herein. As shown in FIG. 6A, in a conventional production and injecting system, fuel and air enter the IC engine which generates power transferred to the power transmission line, hydrogen transferred back to be used in the engine, and wasted power that is released into the ambient environment. In contrast, as shown in FIG. 6B, in the improved electrocatalytic system disclosed herein wasted power is used in the Organic Rankine cycle to generate hydrogen which is used with fuel and air to provide energy to the IC engine which generates power transmitted to the power transmission line. Thus, even though a portion of the wasted power is still released into the ambient environment in FIG. 6B, its thermal energy is reused in the system to generate hydrogen, thus recycling energy and reducing both emissions and fuel consumption.

FIGS. 7A-7B depicts the electrode plates used in an improved electrocatalytic system. FIG. 7A depicts a portion of the grooves on such an electrode plate, while FIG. 7B depicts a side of an electrode plate having grooves for increased surface contact area.

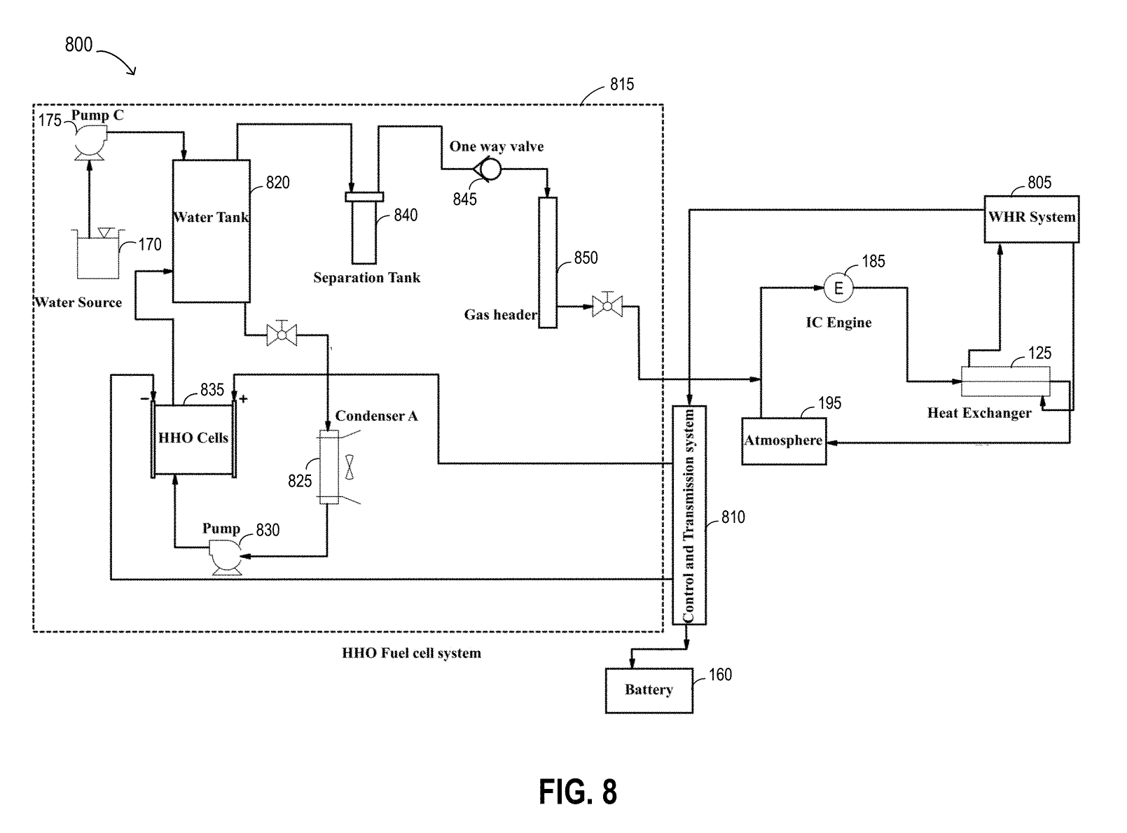

FIG. 8 depicts a block diagram of an improved electrocatalytic system 800 having a waste heat recovery system 805, a control and transmission system 810 and a HHO fuel cell system 815. System 800 is similar to, functions the same way, and includes similar components as those of system 100. However, FIG. 8 also shows some of the internal components of the electrocatalytic converter 165, not shown in FIG. 1. For example, system 800 depicts a water source 170 connected to a pump 175 for pumping water into the water tank 820. The water tank 820 is connected to a condenser 825 to ensure that all gases are turned into liquid before being pumped through pump 830 into the HHO cells 835 where water is electrolyzed and the generated gases are released into the water tank 820 from which they are directed to a separation tank 840. From the separation tank 840, the separated gases are routed through a one-way valve 845 before moving to a gas header which transmits the gases to the IC engine 185.) Functions of similarly numbered items in system 800 are similar to those of system 100 and are not described separately here.

Accordingly, the improved electrocatalytic system provides an efficient, less costly and retrofittable system for reducing harmful emissions and fossil fuel consumption in vehicles by utilizing a Rankine cycle system that takes advantage of exhaust fume heat to generate electricity. The generated electricity is used in electrolyzing water which produces hydrogen used as a supplemental fuel in the engine.

The separation of various components in the examples described above should not be understood as requiring such separation in all examples, and it should be understood that the described components and systems can generally be integrated together in a single packaged into multiple systems.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A system for reducing fossil fuel consumption and emissions in an engine comprising:
a waste heat recovery unit including a condenser connected to a first pump for injecting a working fluid into a heat exchanger configured to convert the working fluid into steam injected into an expander;
a generator connected to the expander for generating electricity;
a battery for storing the generated electricity; and
a water electrolysis unit including a water container for storing water, and a second pump for pumping the water into an electrocatalytic converter,
wherein:
the electrocatalytic converter includes a plurality of electrode plates for conducting the generated electricity through the water to electrolyze the water and generate a hydrogen gas for injection into the engine,
the hydrogen gas reduces an amount of fossil fuel needed for running the engine and reduce engine emissions, and
the heat exchanger uses heat from exhaust fumes emitted from the engine to convert the working fluid to steam.

2. The system of claim 1, wherein the working fluid is 1,1,1,3,3-Pentafluoropropane (R245fa).

3. The system of claim 1, wherein the condenser converts the steam back to the working fluid.

4. The system of claim 1, wherein the steam causes one or more blades of the expander to rotation.

5. The system of claim 4, wherein the rotation causes electricity to be generated in the generated.

6. The system of claim 1, further comprising a switch for selecting a single-fuel option or a dual-fuel option.

7. The system of claim 6, wherein when the single fuel option is selected, the engine only uses fossil fuels.

8. The system of claim 6, wherein when the dual fuel option is selected, the engine uses fossil fuels and the generated hydrogen.

9. The system of claim 7, wherein when the single fuel option is selected, the generator is connected to the battery for storing the generated energy in the battery.

10. The system of claim 8, wherein when the dual fuel option is selected, the generator is connected to the electrocatalytic converter for electrolyzing the water.

11. The system of claim 1, wherein the battery supplies energy to at least one the first pump, the second pump and the condenser.

12. The system of claim 1, wherein each of the plurality of electrode plates have an increased contact surface area.

13. The system of claim 12, wherein the increased contact surface area is created by indentations in each of the plurality of electrode plates.

14. The system of claim 1, wherein each cathode plate of the plurality of electrode plates is made from a different steel than the steel used for each anode plate of the plurality of electrode plates.

15. The system of claim 1, further comprising two absorbing poles placed in an outlet path of the electrocatalytic converter to introduce a stimulating force to the hydrogen gas produced by the electrocatalytic converter.

16. The system of claim 1, wherein the stimulating force increases volumetric efficiency.

17. The system of claim 1, further comprising an active carbon filter fuel dryer used with the electrocatalytic converter.

18. The system of claim 17, wherein the heat exchanger includes a plurality of heat exchange tubes.

19. The system of claim 18, wherein each heat exchange tube has an outer shell, and an inner tube.

20. The system of claim 19, wherein the working fluid moves through the heat exchanger by passing in an area in between the outer shell and the inner tube.
